(19) United States
(12) Patent Application Publication
(10) Pub. No.: US 2025/0023305 A1
(43) Pub. Date: Jan. 16, 2025

(54) COAXIAL PLUG CONNECTION FOR ELECTRICAL CONNECTION OF ELECTRICAL OR ELECTRONIC COMPONENTS HAVING AN AXIAL PLUG

(71) Applicant: OTTO BOCK HEALTHCARE PRODUCTS GMBH, Wien (AT)

(72) Inventors: Martin HASLINGER, Wien (AT); Josef GÜRTL, Wien (AT)

(21) Appl. No.: 18/710,912

(22) PCT Filed: Nov. 15, 2022
(86) PCT No.: PCT/EP2022/081970

§ 371 Date: May 16, 2024

(30) Foreign Application Priority Data
Nov. 23, 2021 (DE) 10 2021 130 658.2

(51) Int. Cl. H01R 24/58; H01R 13/405

(52) U.S. Cl. CPC H01R 24/58; H01R 13/405

(57) ABSTRACT

The invention relates to a coaxial plug connection for electrical connection of electrical or electronic components having an axial plug, which has a plug body with at least one contact surface located on the outer side of the plug body and an axial socket with a plug receptacle formed to correspond with the plug body, in which the plug body is inserted in the joined state and in which at least one contact element is arranged to engage with the contact surface, wherein the contact element is formed as a spring element and has a plurality of contact points or contact areas to the contact surface.

The invention relates to a coaxial plug connection for electrical connection of electrical or electronic components having an axial plug which has a plug body having at least one contact face which is located on the outer side of the plug body and an axial socket having a plug receptacle which is configured to correspond to the plug body and in which the plug body is introduced in the joined state and in which at least one contact element for engagement with the contact face is arranged.

Plug connections for electrically connecting electrical or electronic components are used for permanent and in particular repeatedly releasable and rejoinable connection of two plug components so that the electrical or electronic components can be connected to each other. Such an electrical connection having a capacity for separation is advantageous and conventional, particularly with mechatronic components which have to be produced separately from each other and secured to each other. Coaxial plugs are particularly used in locations where the plug components, that is to say, the plug body and the plug receptacle, have to be configured to be able to rotate about a common axis. For example, this is the case with mechanical components which are supported so as to be rotatable relative to each other.

In prosthetic components, for example, prosthetic hand joints, a secure and permanent contacting between mechatronic elements within the prosthetic hand and an energy supply and control in a proximal prosthetic component, for example, in a lower arm shaft, is particularly important.

An object of the present invention is therefore to provide a permanent and reliable connection between two electrical or electronic components.

This object is achieved with a coaxial plug connection having the features of the main claim. Advantageous embodiments and further developments of the invention are disclosed in the dependent claims, the description and the Figures.

The coaxial plug connection for electrical connection of electrical and electronic components having an axial plug which has a plug body having at least one contact face which is located on the outer side of the plug body and an axial socket having a plug receptacle which is configured to correspond to the plug body and in which the plug body is introduced in the joined state and in which at least one contact element for engagement with the contact face is arranged, makes provision for the contact element to be in the form of a resilient element and to have a plurality of contact locations with the contact face. As a result of the arrangement and configuration of the contact element as a resilient element, which has a plurality of contact locations with the contact face, a secure contacting of the contact face and contact element is ensured since the contact element is pretensioned in a resilient manner in the direction toward the contact face in the joined state. As a result of the plurality of contact locations between the contact element and the contact face, an extensive contacting which takes a place at a plurality of locations is enabled so that a good signal transfer or a good transmission of signals or power can be carried out.

In one embodiment, the contact element is provided with at least one abutment region or forms an abutment region which has over a partial circumference of the contact face a contour which corresponds to the contact face. It is thereby possible not only for a localized contacting to take place at a plurality of contact locations or contact lines, but also for an extensive contacting to be possible. With a corresponding contour between the contact face and the contact element there is produced not only a linear or a plurality of occurrences of linear contacting, but instead an extensive, in particular complete contacting over the partial circumference of the contact face.

In one embodiment, the contact face is configured in an annular or rounded manner so that a rotation of the plug body relative to the plug receptacle is possible. In particular with a contact face which is configured in an annular manner and which is then in the form of a cylindrical covering face at least over a part-region of the axial extent of the plug, a slight rotation through 360° can be carried out, with a curved or rounded configuration of the contact face, a rotation will lead to a change of the faces which enable an energy transmission or signal transmission between the plug body and the plug receptacle.

In one embodiment, a plurality of contact faces and/or contact elements are arranged one behind the other in the axial direction of the plug body so that a plurality of lines for transmission of information and/or energy within the coaxial plug connection are provided. This is particularly advantageous for the supply of complex components in orthopedic technology. In prosthetic hands, a large number of electric drives are sometimes controlled so that for each drive a separate contact face or separate contact elements may be formed within the coaxial plug connection.

In one embodiment, the contact element is secured to a contact plate and coupled in an electrically conductive manner to a contact field of the contact plate. The contact plate is, for example, a printed circuit board which is secured to one of the components, for example, the prosthetic hand, and which can be connected to the continuing lines. On the contact plate, additional electrical connections or connection locations may be provided, for example, by means of so-called pogo pins.

The contact element may be secured to a carrier, to which the contact plate is in turn secured. The carrier may be secured in or formed on the axial socket in a releasable or materially engaging manner in order to enable a stable connection of the contact element to the axial socket. A releasable securing of the carrier to the axial socket can facilitate the production and where applicable can enable changes in the nature or in the contacting. A materially engaging securing provides a permanent, non-releasable securing of the originally separate carrier to the axial socket, wherein a subsequent separation of the carrier and axial socket is not possible without cancelling the materially engaging connection. When the carrier is formed on the axial socket, for example, in the context of a casting process or in an additive production method, a particularly tight and stable and simple production of the axial socket can be achieved.

Advantageously, the contact field is accessible from the outer side so that additional contacts can be secured to the contact field. This securing is carried out independently of the releasable plug connection between the axal socket and axial plug and enables securing or arrangement of the axial socket on the respective component, for example, a prosthetic hand or a prosthetic arm.

In one embodiment, the axial socket is made from a plastics material, in particular from a non-conductive plastics material, wherein the contact element is formed in the axial socket. The resilient contact elements or the resilient contact element is inserted in the plastics material and extends through it in the direction toward the contact plate and further constitute a resilient possible contact with the plug body. As a result of the plastics material, when the axial plug is inserted the mechanical loading is kept away from the contact plate, furthermore, as a result of the casting of the contact elements or the contact element, a very good shielding against external environmental influences is provided.

In one embodiment, a seal is arranged between the axial plug and the axial socket so that the space between the axial plug and the axial socket is protected from external influences, in particular from moisture, so that a contacting which was once present remains or at least the risk of corrosion is reduced.

Also with a releasable securing of a carrier to the axial socket, a seal may be provided at that location in order after the assembly to keep external influences and in particular moisture away from the connection region.

One embodiment of the coaxial plug connection makes provision for a ventilation hole and/or a securing device for securing the axial socket to a retention member to be arranged or formed on the axial socket. The ventilation opening facilitates the introduction of the axial plug into the axial socket, furthermore this ventilation opening can at the same time subsequently be closed, for example, by means of a securing device or by means of a securing member by means of which, for example, the axial socket is connected to the axial plug.

Advantageously, the axial socket is configured in a resilient manner so that a deformation is possible when the axial plug is inserted and leads to a resilient restoring force of the entire axial socket, in particular of the housing with the contact elements arranged therein. As a result of the resilient configuration of the axial socket, a sealing effect is additionally achieved.

Exemplary embodiments of the invention are explained in greater detail below with reference to the appended Figures, in which:

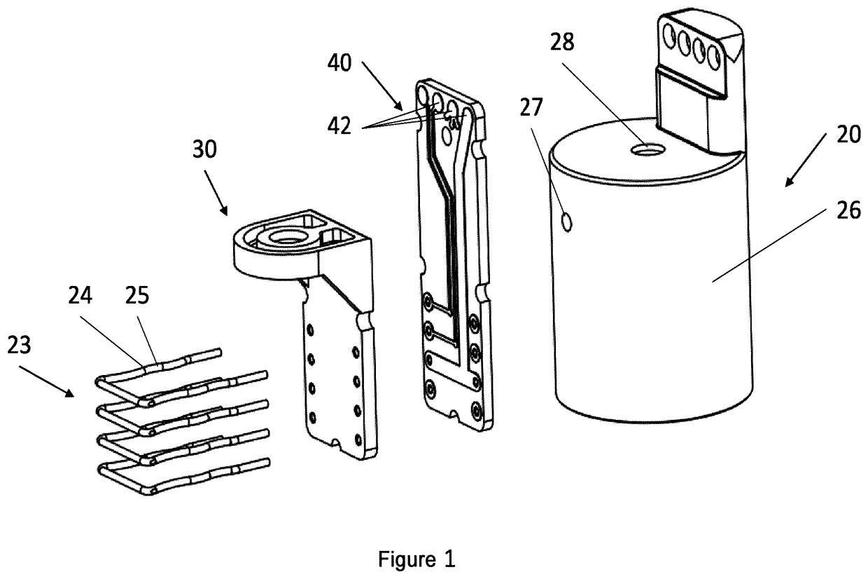

FIG. 1—shows an exploded illustration of an axial socket;

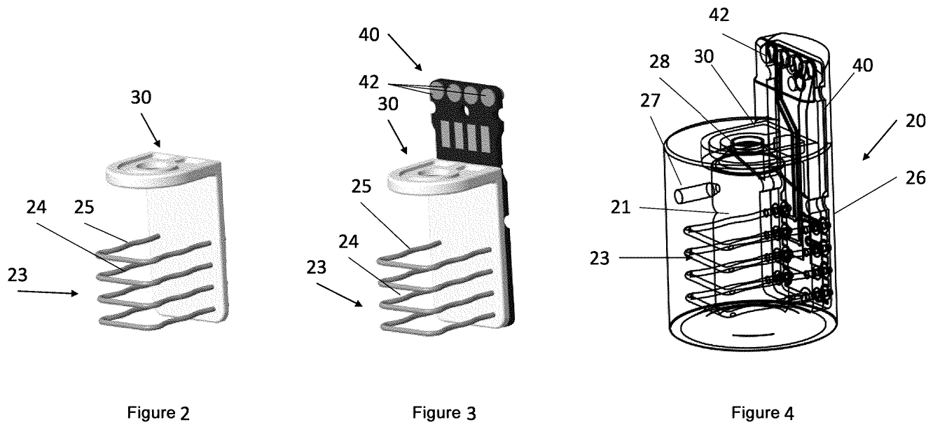

FIG. 2—shows a detailed view of a carrier and contact elements;

FIG. 3—shows a detailed view of a carrier having a contact plate and contact elements;

FIG. 4—shows an illustration of the axial socket according to FIG. 1 in a joined state;

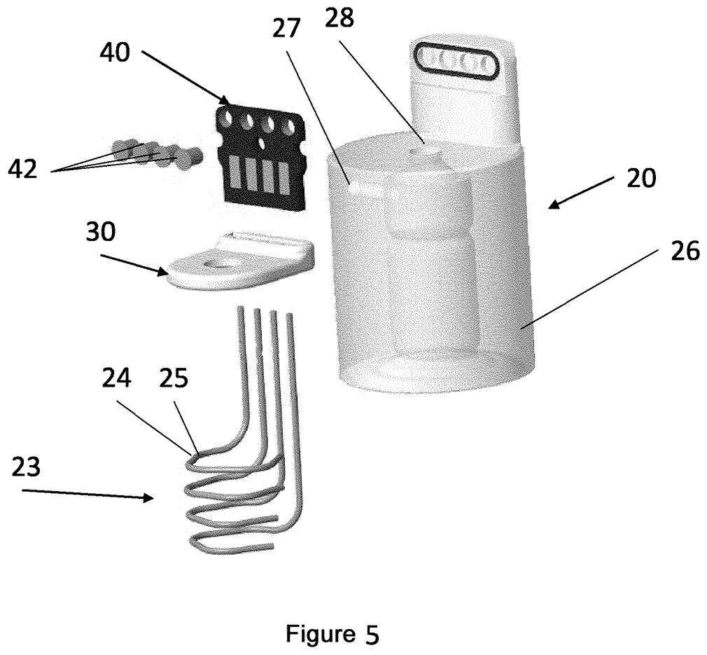

FIGS. 5-8 show variants of FIGS. 1 to 4;

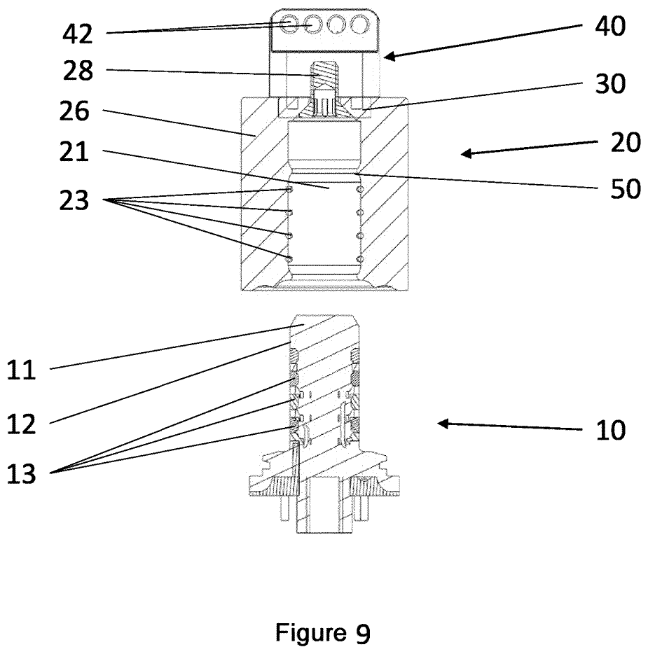

FIG. 9 shows an axial socket and an axial plug as a sectioned illustration; and

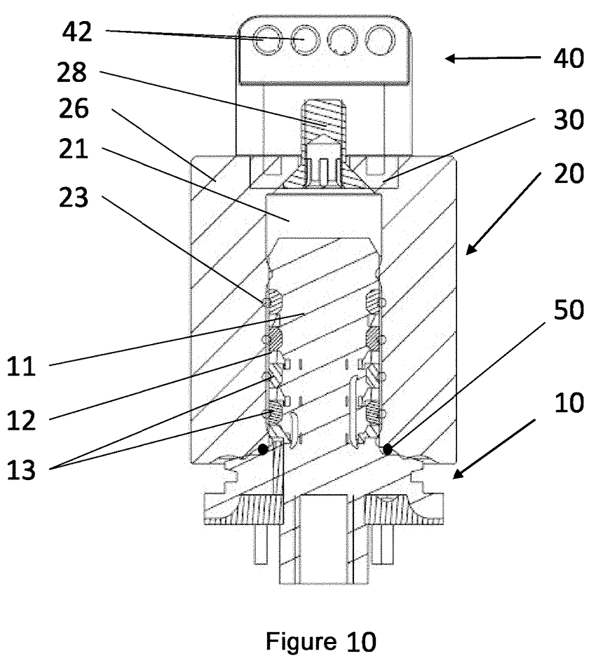

FIG. 10 shows an axial socket and an axial plug in the joined state.

FIG. 1 shows an exploded illustration of an axial socket 20 and the components which are arranged therein. The axial socket 20 has a housing 26 which substantially has a circular cross section. In the interior of the housing 26 a plug receptacle 21 which can be seen in FIG. 4 is in the form of a hollow space for receiving a plug body of an axial plug which is not illustrated. The housing 26 may comprise a resilient material, in particular a resilient plastics material, and has in the exemplary embodiment illustrated at the lower side the introduction opening for the axial plug. At the upper side a securing device 28 with respect to the introduction opening is formed on the housing 26. The securing device 28 is used, for example, for introducing a screw or a pin or another connection element and, for example, secures the axial plug within the axial socket 20. On the side wall of the housing 26 there is formed a ventilation opening 27 which leads inside the housing 26 to the plug receptacle and from which the air inside the plug receptacle escapes when the axial plug is introduced. Within the channel which leads from the plug receptacle to the ventilation opening 27, for example, there may be arranged a check valve which prevents a backflow of air and consequently also moisture from being introduced through the ventilation opening 27 into the plug receptacle. Another component of the plug socket 20 is a contact plate 40 which, for example, is made from a dimensionally stable material, for example, a fiber composite material or a duromer. On the contact plate 40, a plurality of contact fields 42 are formed at the upper end, for example, faces made of electrically conductive material, from which strip conductors or conductors extend downward. The contact fields 42 are in the illustrated embodiment arranged in a row one beside the other and in the joined state are accessible from the outer side through holes within an upwardly protruding continuation of the housing 26. Via the strip conductors, the contact fields 42 are in electrical contact with the contact elements 23. The contact elements 23 are in the form of resilient elements, in the exemplary embodiment illustrated four contact elements 23 are arranged with spacing from each other, in an axial direction one above the other or in the insertion direction of the axial plug 10 one behind the other. The contact elements 23 are in this instance mechanically secured to a carrier 30 which is constructed in a substantially L-shaped manner and which has through-holes for contact ends of the contact elements 23. The contact ends of the contact elements 23 are guided through the through-holes in the downwardly directed portion of the carrier 30 and introduced into plug contacts on the contact plate 40 and placed into electrical connection with the strip conductors and consequently with the contact fields 42 at that location. A receiving region for the securing element 28 is arranged at the upper end of the carrier 30. A seal can be inserted within a recess in the roof face of the carrier so that after the carrier 30 has been introduced into the housing 26 at the upper side, there is a sealed connection between the carrier 30 and the inner side of the housing 26. The contact plate 40 protrudes in the joined state into the upwardly directed projection or continuation of the housing 26 of the axial socket 20 so that the contact fields 42 are orientated toward the openings within the projection. The contact fields 42 can then via an additional contacting device be connected to other electrical or electronic components.

The contact elements 23 are configured in a bow-shaped manner and have a substantially U-shaped form. On both lateral legs there are formed contact regions 25 which are in the form of rounded portions or rounded regions and which bear on the outer contour of the axial plug and on the circumference of the contact faces in the joined state. Furthermore, a plurality of contact locations 24 are formed by each contact element 23 with the associated contact face on the axial plug so that a plurality of contact locations 24 or contact regions 25 are formed on each contact element 23. In the joined state with the axial plug 10, the contact elements 23 bear at a plurality of contact locations 24 and/or contact regions 25 on the outer circumference of the axial plug at the contact faces. To this end, the contact elements 23 are supported within the axial socket 20 in such a manner that they protrude in the non-joined state into the plug receptacle 21 and are moved outward by the axial plug being introduced so that in the joined state they then press with a pretensioning force against the contact faces.

As a result of the curved configuration of the contact regions 25, the surface-area of the contact regions which are in contact increases with respect to the contact faces on the axial plug so that with a round cross section of the resilient elements or the contact elements 23 there is not only a localized contact at the outer side of the contact faces, but also a linear or surface abutment of the contact elements 23 against the contact faces takes place. Alternatively, the cross section is elliptical; a rectangular cross section would constitute an even greater abutment face. In the exemplary embodiment illustrated, the contact regions 25 are located opposite each other, it is also possible, and there is also provision, for a contact region or a rounded portion to be formed on the curved portion of the curved contact element 23. Consequently, from two opposing sides or from three sides, a large number of resilient forces can act on the axial plug as a result of the contact element 23 and bring about a clamping contacting. As a result of the rounded contour of the contact regions 25, corresponding to the round or rounded outer side of the axial plug and a correspondingly rounded or round contact face of the axial plug, a rotation of the plug within the axial socket 20 is possible without the contacting being cancelled. In contrast to the four contact elements 23 illustrated, more or fewer contact elements 23 can also be arranged one behind the other in an axial direction of the introduction direction.

FIG. 2 shows a detailed view of the carrier 30 with contact elements 23 which are already secured thereto. The contact or conductor ends of the U-shaped contact elements 23 protrude through the holes in the downwardly protruding portion of the L-shaped carrier 30.

FIG. 3 shows a module after an additional assembly step in which the contact plate 40 is connected to the contact ends or contact pins of the contact elements 23. The contact plate 40 is arranged at the rear side of the carrier 30, for example, adhesively bonded, welded or secured thereto in another manner so that, as a result of the carrier 30, mechanical loads which are transmitted to the contact elements 23 when the plug is introduced and pulled out are not transmitted to the contact plate 40. The contact plate 40 protrudes beyond the angled upper portion of the carrier 30 and can thereby be used in the finally joined state from the outer side for further contacting at the contact fields 42.

FIG. 4 illustrates the axial socket 20 in a finished, joined state as a partially transparent view. In the interior of the axial socket 20, the plug receptacle 23 which substantially forms a hole or a round receptacle for introducing the axial plug with the plug body can be seen. The access opening is at the lower side of the housing 26 in which the carrier 30 together with the resiliently configured contact elements 23 and the contact plate 40 is arranged. The combination of contact elements 23, carrier 30 and contact plate 40 as shown in FIG. 3 can be inserted into the resilient housing 26 and be secured thereto. The contact elements 23 protrude at least partially into the plug receptacle 21 and then provide the electrical contacting with respect to the contact plate 40 and the contact fields 42. At the upper side of the plug receptacle 21, there is formed a free space which has a ventilation opening 27 which leads outward and which is sealed or which is provided with a check valve and which facilitates the introduction of the axial plug. The ventilation opening 27 is in this instance sealed in such a manner that air can escape when the plug is introduced, but dirt and moisture are not introduced. As a result of the securing device 28, a retention member can be introduced or a screw or a securing element in engagement with a corresponding receptacle on the angled portion of the carrier 30 can be inserted and secured.

A seal is arranged between the carrier 30 and the upper side of the housing 26. A seal can also be arranged or formed on the outer circumference of the axial plug and/or on the lower side of the housing 26 in order in an assembled and joined state to shield the contact locations between the contact elements 23 and the contact faces 13 of the axial plug.

FIG. 5 shows a variant in the axial socket 20 as an exploded illustration, the structure of which substantially corresponds to that of FIG. 1. The housing 26 substantially corresponds to the housing 26 of FIG. 1, in contrast the four contact elements 23 are not configured in a U-shaped manner in a plane, but instead have only an upwardly leading contact end from which a curved contact member is bent round substantially at right-angles so that a curved U-shaped contact element 23 with a plurality of contact regions 25 and contact locations 24 is produced. The upwardly leading contact portions protrude through openings in a disk-like or plate-like carrier 30 on which a contact plate 40 having contact fields 42 and contacting regions for electrical contacting with the contact ends of the contact elements 23 are arranged.

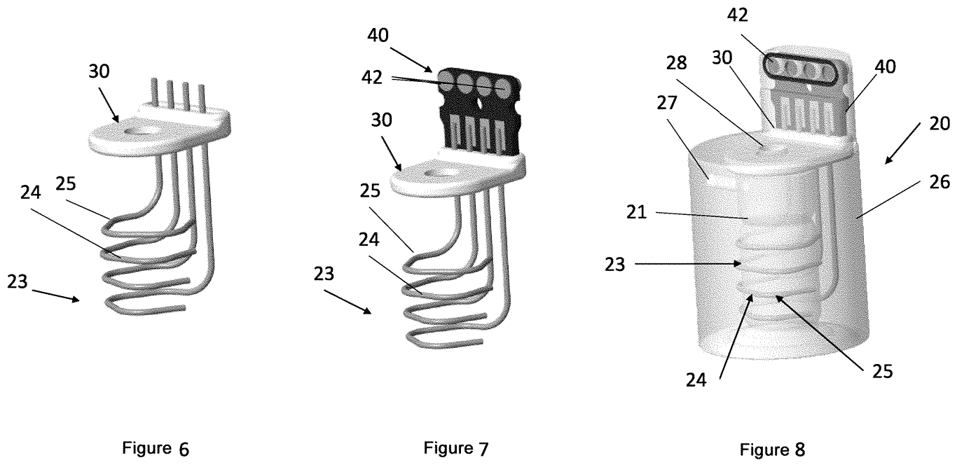

In FIG. 6, the carrier 30 with the contact elements 23 arranged therein is illustrated alone. The contact ends of the contact elements 23 protrude upward through the openings inside the carrier 30. The contact locations 24 and contact regions 25 on the downwardly protruding contact elements are bent out in a U-shaped manner and configured in a resilient manner. The respective contact elements 23 with the double-bent contact regions 25 are arranged one behind the other in different planes so that they are located one behind the other in the introduction direction of the axial plug. The contact regions 25 may also be configured to be bent three times.

In FIG. 7, the securing of the contact plate 40 to the contact fields 42 at the contact ends of the contact elements 23 is shown. The contact plate 40 is mechanically secured to the carrier 30 so that mechanical vibrations or deformations during contacting with the axial plug do not influence the electrical contacting.

In FIG. 8, the completely assembled axial socket 20 with the resilient housing and the four contact elements 23 which are mentioned therein and which are spaced apart one behind the other in an axial direction are shown with the contact regions 25 and the plurality of contact locations 24. The curved, partially rounded ends of the contact elements 23 which protrude into the plug receptacle 21 are configured in a resilient manner and can be cast, injected or inserted into the housing 26. In this instance, a sealing, and a securing of the carrier 30 to the housing 26, for example, via a clip-fit connection, a screw connection or via another securing device 28 is also possible and provided. A seal is also arranged at the lower side of the introduction opening in the plug receptacle 21.

FIGS. 9 and 10 illustrate a sectioned illustration of a coaxial plug connection having an axial plug 10 and an axial socket 20, in FIG. 9 in a non-joined state, in FIG. 10 in a completely joined state. The axial plug 10 has a plug body 11 which has a substantially round cross section and along the longitudinal extent thereof on the outer side 12 thereof has a plurality of contact faces 13 which can be electrically separated from each other and which in the exemplary embodiment illustrated extend circumferentially around the entire circumference of the axial plug 10. It is thereby possible to rotate the axial plug through 360° within the axial socket 20 without an electrical contact being interrupted. The electrical contact is formed between the contact faces 13 of the axial plug 10 and the contact elements 23 on the inner side of the plug receptacle 21 of the axial socket 20. Within the axial socket 20 on the housing 26 the contact plate 40 is mounted on the carrier 30 and a screw 28 is mounted as a securing element. The securing element 28 can at the same time be used as an assembly element for securing the axial socket 20 on another component. On the contact plate 40, there are arranged the four contact fields 42 which are electrically connected to the respective contact elements 23. Each contact element 23 is electrically connected only to one contact field 42. It is thereby possible for a contact face 13 of the axial plug 10 to be electrically connected to precisely one contact field 42 of the contact plate 40. The contact faces 13 terminate flush with the remaining outer side 12 of the axial plug 10 or the plug body 11 which protrudes into the plug receptacle 21. In the sectioned illustration, it can be seen that the contact elements 23 protrude into the plug receptacle 21. When the plug body 11 is pushed into the plug receptacle 21, the resiliently formed or resiliently stored contact elements 23 are pressed outward and bear securely on the contact faces 13 in the joined state with a coaxial plug connection being formed.

In FIG. 10, the coaxial plug connection is shown in a joined state. Above the plug body 11, there is formed within the plug receptacle 21 a free space which is connected to the ventilation opening 27 which is not illustrated. When the axial plug 10 is introduced, the air is pressed into the free space and out of the free space through the ventilation opening into the environment. At the inner side of the plug receptacle 21, at the height of the front end of the plug body 11, there is formed an inwardly protruding projection which can best be seen in FIG. 9. The projection acts as a first seal 50 in the introduced state which can be seen in FIG. 10. The circumferential projection clamps on the outer circumference of the plug body 11 and acts, on the one hand, as sealing against moisture or the like being introduced through the ventilation opening 27 or through the securing device 28 and, on the other hand, as a mechanical safety member against falling out of the plug receptacle 21. A second seal 50 is arranged on a contact face between the lower end of the housing 26 and a shoulder on the plug body 11, for example, as an O ring or another sealing form. As a result of the two seals 50, the electrical contact contacting region between the contact faces 13 and the contact elements 23 is securely sealed.

1. A coaxial plug connection for electrical connection of electrical or electronic components, comprising:
an axial plug which has a plug body having at least one contact face which is located on an outer side of the plug body;
an axial socket having a plug receptacle configured to correspond to the plug body, wherein the axial socket is configured such that the plug body is introduced in a joined state, and wherein the axial socket comprises at least one contact element for engagement with the at least one contact face, wherein the at least one contact element is a resilient element and has a plurality of contact locations and/or contact regions for contacting the at least one contact face.

2. The coaxial plug connection as claimed in claim 1, wherein the at least one contact element has at least one contact region which has over a partial circumference of the at least one contact face a contour which corresponds to the at least one contact face.

3. The coaxial plug connection as claimed in claim 1 wherein the at least one contact face is configured in an annular or rounded manner.

4. The coaxial plug connection as claimed in claim 1 wherein the at least one contact face includes a plurality of contact faces and wherein the at least one contact element includes a plurality of contact elements, and wherein the plurality of contact faces and/or the plurality of contact elements are arranged one behind the other in an axial direction of the plug body.

5. The coaxial plug connection as claimed in claim 1 wherein the at least one contact element is secured to a contact plate and coupled in an electrically conductive manner to a contact field of the contact plate.

6. The coaxial plug connection as claimed in claim 5, wherein the at least one contact element is secured to a carrier to which the contact plate is secured.

7. The coaxial plug connection as claimed in claim 6, wherein the carrier is secured to or formed on the axial socket in a releasable or materially engaging manner.

8. The coaxial plug connection as claimed in claim 5 wherein the contact field is accessible from an outer side of the contact plate.

9. The coaxial plug connection as claimed in claim 1 wherein the axial socket is or includes a housing made from a plastics material and the at least one contact element is formed in the axial socket.

10. The coaxial plug connection as claimed in claim 1 further comprising at least one seal arranged between the axial plug and the axial socket.

11. The coaxial plug connection as claimed in claim 1 further comprising a ventilation opening arranged or formed on the axial socket and/or a securing device for securing the axial socket to a retention member is arranged or formed on the axial socket.

12. The coaxial plug connection as claimed in claim 1 wherein the axial socket is configured in a resilient manner.
